(19) United States
(12) Patent Application Publication
(10) Pub. No.: US 2011/0095076 A1
(43) Pub. Date: Apr. 28, 2011

(54) BLANKS AND BOXES WITH TONGUE-POCKET BOTTOM COMBINATION FORMABLE FROM SAID BLANKS

(76) Inventor: Patrick Charles William Knighton, Derbyshire (GB)

(21) Appl. No.: 12/921,187

(22) PCT Filed: Dec. 1, 2008
(86) PCT No.: PCT/GB2008/003991

§ 371 Date: Dec. 6, 2010

(30) Foreign Application Priority Data
Mar. 6, 2008 (GB) 0804191.5

(51) Int. Cl. B65D 5/10; B65D 5/42; B31B 49/02

(52) U.S. Cl. 229/185; 229/100; 493/183

(57) ABSTRACT

A box (10) having a box sidewall composed of a closed string of side wall forming panels (18) which defines a tube having a desired polygonal cross sectional shape, the side wall forming panels (18) each having a bottom edge (23) which together define one end of the tube, and a box bottom wall (12) extending across and closing off said one end of the tube, the box bottom wall (12) being composed of a plurality of side by side separate bottom wall forming panels (19), each separate bottom wall forming panel hingeably depending from a bottom edge (23) of a respective side wall forming panel (19), each separate bottom wall forming panel (19) having a tongue (60, 62) laterally projecting from one of its sides and a tongue receiving pocket (80, 82b) laterally projecting inwardly from its opposite side, neighbouring bottom wall forming panels (19) being inter-connected to one another by the tongue (60, 62) of one bottom wall forming panel (19) being accommodated internally within the pocket (80, 82b) of the neighbouring bottom wall forming panel.

The present invention relates to a box (or container) formed from sheet material, a blank for forming the box and a method for assembling a box.

It is desirable to produce a box which can be stored and/or transported to a point of use whilst in a lay-flat condition. Many examples of such boxes exist but unfortunately they are generally difficult for to erect from a lay-flat condition to a fully erected box condition either manually by an operative or automatically by a robot.

A general aim of the present invention is to provide a box which is simple to erect from a lay-flat condition to a fully erected box condition.

Another general object of a particular embodiment of the present invention is to provide a box which in the fully erected condition is able to carry relatively heavy loads compared to the strength of the material from which the box is made.

Another general object of a particular embodiment of the present invention is to provide a box made from a sheet of resilient material.

According to one aspect of the present invention there is provided a box having a box sidewall composed of a closed string of side wall forming panels which defines a tube having a desired polygonal cross sectional shape, the side wall forming panels each having a separate bottom edge which together define one end of the tube, and a box bottom wall extending across and closing off said one end of the tube, the box bottom wall being composed of a plurality of separate side by side bottom wall forming panels, each separate bottom wall forming panel hingeably depending from a bottom edge of a respective side wall forming panel, each bottom wall forming panel having a tongue laterally projecting from one of its sides and a tongue receiving pocket laterally projecting inwardly from its opposite side, neighbouring bottom wall forming panels being inter-connected to one another by the tongue of one bottom wall forming panel being accommodated internally within the pocket of the neighbouring bottom wall forming panel.

Each bottom wall forming panel may comprise a pair of overlying layers creating a space therebetween, the space between the layers on one side of the bottom wall forming panel defining said tongue receiving pocket and the pair of layers on the opposite side of the bottom wall forming panel defining said tongue.

Each bottom wall forming panel may be in the form of a flap having a medial foldline parallel to the hinge line along the bottom edge of its associated side wall forming panel, the medial fold line dividing the flap into a first flap portion located between the bottom edge of the associated side wall forming panel and the medial fold line and a second flap portion located between the medial fold line and a terminal edge of the flap, the first and second flap portions being folded about the medial fold line to define said pair of overlying layers of the bottom wall forming panel, the folded medial foldline defining an inner terminal edge of the bottom wall forming panel.

The medial fold line may be spaced from the bottom edge of its associated side wall forming panel by a distance such that the inner terminal edge of each bottom wall forming panel is located on or closely adjacent to the axis of the tube.

The terminal edge of the flap may be parallel to the medial fold line and is spaced therefrom by a distance such that the terminal edge is located close to the bottom edge of the associated side wall forming panel.

A marginal end flap may be foldably attached to said terminal edge of the flap, the marginal end flap overlying the inner face of the associated side wall forming panel.

One or more respective pairs of bottom wall forming panels may be provided with latch engagement means which co-operate to resist hingeable movement of each bottom wall forming panel about the bottom edge of its associated side wall forming panel.

Said string may be composed of an odd number of side wall forming panels, one of said side wall forming panels and its associated bottom wall forming panel each having a medial foldline extending parallel to the hinge connections between the side wall forming panels, said medial fold line providing for folding of one side wall forming panel and associated bottom wall forming panel in order to enable the side wall forming panels to assume said lay-flat condition from which the box can be erected

The box may be made from a single blank of sheet material. The sheet material may be card, cardboard, or plastic and combinations thereof (including plastic coated card/cardboard).

The sheet material may be a resilient material. The resilient material may be a plastics, such as polypropylene or polyethylene. The resilient material may be a card or cardboard laminated with one or more layers of plastics film.

According to another aspect of the present invention there is provided a blank formed from a single sheet of material for forming a box as defined above, the blank being formed to define an open string of side wall forming panels with adjacent side wall forming panels being hingeably connected by respective foldlines, the blank also being formed to define respective separate bottom wall forming panels hingeably depending from a bottom edge of each side wall forming panel, and wherein the side wall forming panels located at the terminal end of the string are adapted for hingeable connection to one another in order to form, when connected, said closed string of side wall forming panels, the side wall forming panels being capable of being hingeably moved relative to one another to define said tube, each separate bottom wall forming panel being arranged to provide a tongue laterally projecting from one of its sides and a tongue receiving pocket laterally projecting inwardly from its opposite side, neighbouring bottom wall forming panels being arranged to be inter-connected to one another by the tongue of one bottom wall forming panel being accommodated internally within the pocket of the neighbouring bottom wall forming panel during forming of a box.

The base wall forming panels may be hinged from the bottom edge of each respective side wall panel to project out through the string of side wall forming panels. The base wall forming panels may be hinged from the bottom edge of each respective side wall panel to project out through the connected string of side wall forming panels.

According to another aspect of the present invention there is provided a collapsed box in a lay-flat condition formed from a blank as defined above, wherein the base wall forming panels are hinged from the bottom edge of each respective side wall panel to project out through the string of side wall forming panels.

According to another aspect of the present invention there is provided a collapsed box in a lay-flat condition formed from a blank as defined above, wherein the base wall forming panels are hinged from the bottom edge of each respective side wall panel to project out through the string of side wall forming panels, the side wall forming panels hinged by said side wall forming panel fold lines to define a lay-flat condition.

According to another aspect of the present invention there is provided a collapsed box in a lay-flat condition formed from a blank as defined above, wherein the side wall forming panels located at the terminal end of the string are hingeably joined to form said closed string of side wall forming panels and the side wall forming panels are hingeably moved to a condition where opposed side wall forming panels are located in close face to face proximity to one another to define said lay-flat condition.

The lay-flat condition may be provided by hingeably moving the bottom wall forming panels, about respective bottom edges of the respective side wall forming panels, through the closed string of side wall forming panels such that respective bottom wall forming panels hingeably sandwich respective side wall forming panels therebetween.

The lay-flat condition is provided by hingeably moving the bottom wall forming panels, about respective bottom edges of the respective side walls, prior to formation of the closed string of side wall forming panels, such that the bottom wall forming panels are located in between said opposed side forming panels.

According to another aspect of the present invention there is provided a method of forming a box comprising forming a blank as defined above, hingeably joining the side wall forming panels located at opposite ends of the open string in order to form said closed string of side wall forming panels, moving the closed string of side wall forming panels relative to one another to form said tube and hingeably moving the separate bottom wall forming panels toward the end of the tube defined by the bottom edges of the side wall forming panels in order to cause insertion of each tongue of one bottom wall forming panel into a co-operating pocket of a neighbouring bottom wall forming panel.

The method may comprise moving the bottom wall panels to be internal to the closed string prior to creation of the closed string of side wall forming panels. The method may comprise moving the bottom wall panels to be internal to the closed string following the creation of the closed string of side wall forming panels.

According to another aspect of the present invention there is provided a method of forming a box comprising forming a blank as defined above, the method comprising moving the closed string of side wall forming panels relative to one another to form said tube, and hingeably moving the separate bottom wall forming panels toward the end of the tube defined by the bottom edges of the side wall in order to cause insertion of each tongue of one bottom wall forming panel into a co-operating pocket of a neighbouring bottom wall forming panel.

The method may comprise moving the bottom wall panels to be internal to the closed string prior to creation of the closed string of side wall forming panels. The method may comprise moving the bottom wall panels to be internal to the closed string following the creation of the closed string of side wall forming panels.

According to a further aspect, there is provided a box having a box sidewall composed of a closed string of side wall forming panels which defines a tube having a desired polygonal cross sectional shape, the side wall forming panels each having a separate bottom edge which together define one end of the tube, and a box bottom wall extending across and closing off said one end of the tube, the box bottom wall being composed of a plurality of separate side by side bottom wall forming panels, each separate bottom wall forming panel hingeably depending from a bottom edge of a respective side wall forming panel, each bottom wall forming panel having an oblique crease line to define a flap portion and a tab portion, the oblique crease line providing for folding of the tab portion over the flap portion to provide a composite thickness bottom wall, the tab portion configured to rest on the tab portion of an adjacent bottom wall forming panel in the erected box.

According to another aspect of the present invention there is provided a blank formed from a single sheet of material for forming a box as defined in the further aspect, the blank being formed to define an open string of side wall forming panels with adjacent side wall forming panels being hingeably connected by respective foldlines, the blank also being formed to define respective separate bottom wall forming panels hingeably depending from a bottom edge of each side wall forming panel, and wherein the side wall forming panels located at the terminal end of the string are adapted for hingeable connection to one another in order to form, when connected, said closed string of side wall forming panels, the side wall forming panels being capable of being hingeably moved relative to one another to define said tube, each bottom wall forming panel having an oblique crease line to define a flap portion and a tab portion, the oblique crease line providing for folding of the tab portion over the flap portion to provide a composite thickness bottom wall, the tab portion configured to rest on the tab portion of an adjacent bottom wall forming panel in the erected box.

The blank may be configured such that adjacent tab portions rest on one another in an upstanding configuration when the respective tab portions are folded about the respective oblique crease lines and the created folded tab/flap portions are internal to the closed string side wall forming panels.

The blank may be configured such that adjacent tab portions rest on one another in an upstanding configuration when the respective tab portions are folded about the respective oblique crease lines and the created folded tab/flap portions are hingedly moved about their respective bottom edges to be internal to the closed string side wall forming panels.

According to another aspect of the present invention there is provided a method of forming a box comprising forming a blank as defined in relation to the further aspect, hingeably joining the side wall forming panels located at opposite ends of the open string in order to form said closed string of side wall forming panels, moving the closed string of side wall forming panels relative to one another to form said tube and hingeably moving the separate bottom wall forming panels toward the end of the tube defined by the bottom edges of the side wall forming panels in order to cause adjacent tab portions to rest on one another to define an interlocking composite thickness bottom wall.

The method may comprise moving the bottom wall panels to be internal to the closed string prior to creation of the closed string of side wall forming panels. The method may comprise moving the bottom wall panels to be internal to the closed string following the creation of the closed string of side wall forming panels.

According to another aspect of the present invention there is provided a method of forming a box comprising forming a blank as defined in respect of the further aspect, the method comprising moving the closed string of side wall forming panels relative to one another to form said tube, and hingeably moving the separate bottom wall forming panels toward the end of the tube defined by the bottom edges of the side wall in order to cause adjacent tab portions to rest on one another to define an interlocking composite thickness bottom wall.

The method may comprise moving the bottom wall panels to be internal to the closed string prior to creation of the closed string of side wall forming panels. The method may comprise moving the bottom wall panels to be internal to the closed string following the creation of the closed string of side wall forming panels.

Various aspects of the present invention are hereinafter described with reference to the accompanying drawings, in which:—

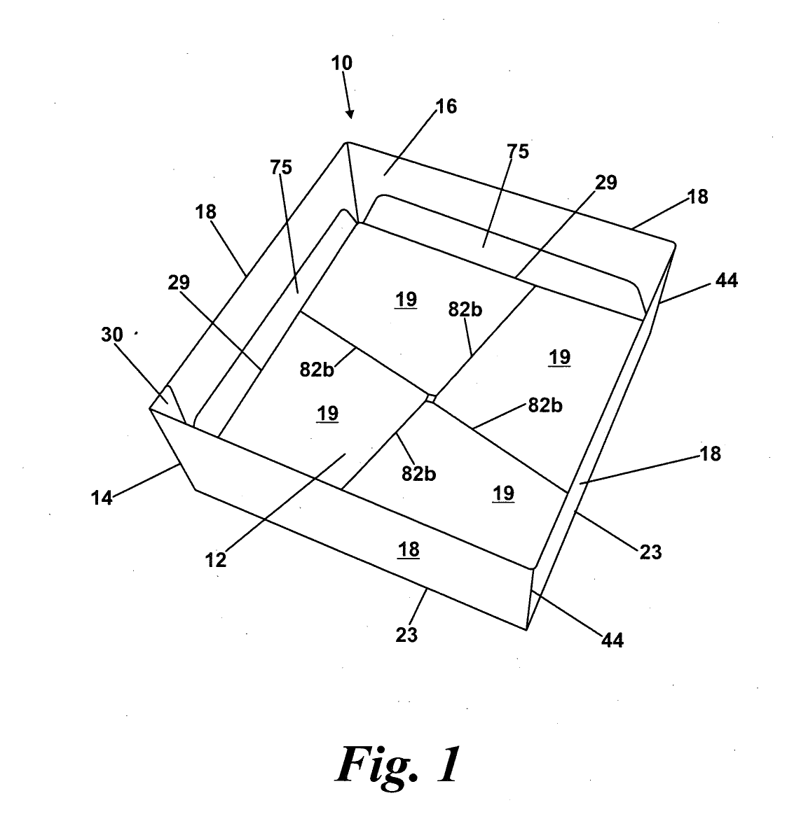

FIG. 1 is a schematic perspective view of a box according to an embodiment of the invention;

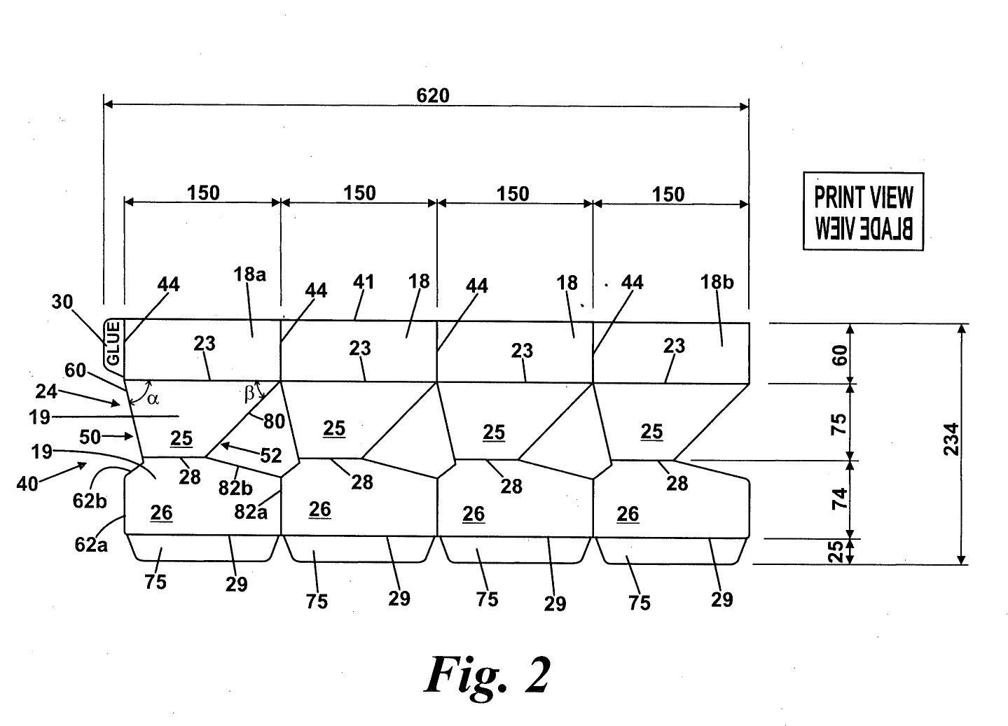

FIG. 2 is a plan view of a blank of sheet material cut and scored for forming the box of FIG. 1;

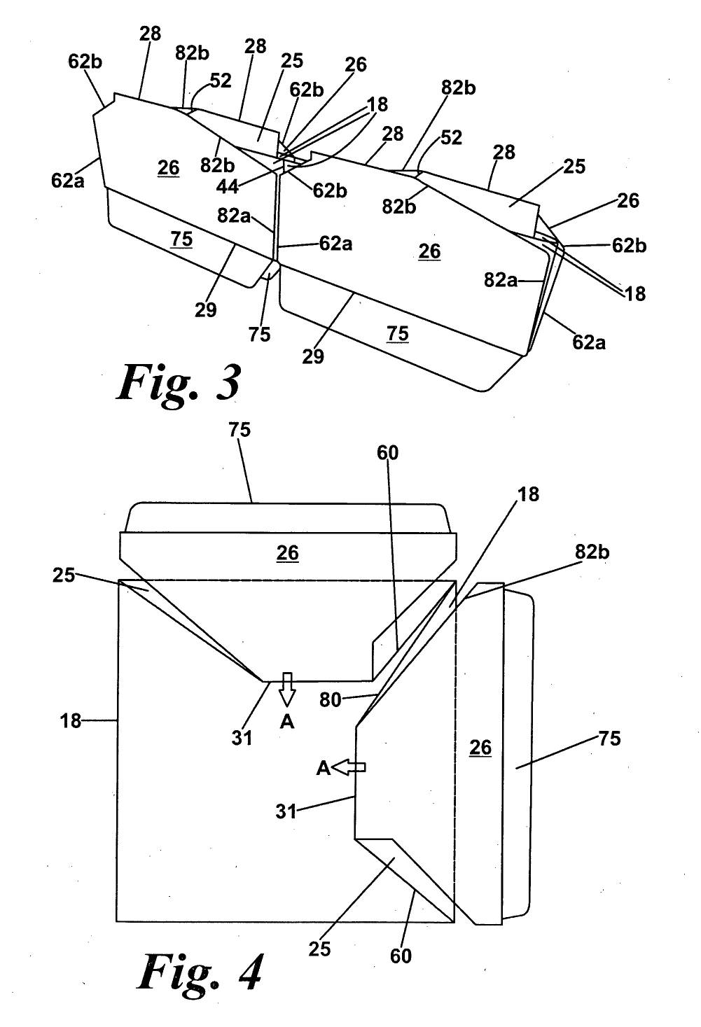

FIG. 3 is an outer perspective view of the blank of FIG. 2 after being formed into a collapsed, lay-flat, condition from which a fully erected box can be formed;

FIG. 4 is a plan view illustrating the erection of a box from the collapsed condition shown in FIG. 3 (only two bottom wall forming panels are illustrated for clarity purposes);

FIG. 5 is a plan view of the partially assembled box as shown in FIG. 4 after the tongue and co-operating pockets of the two bottom wall forming panels have been initially inserted one into the other;

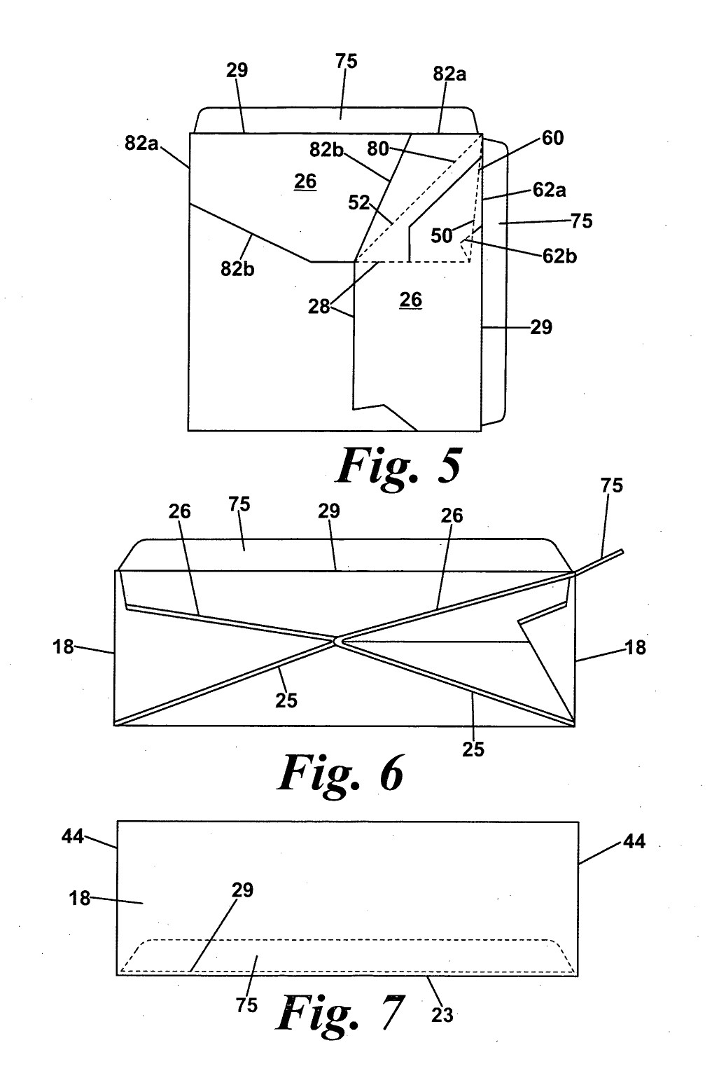

FIG. 6 is a side view of the partially erected box as shown in FIG. 5;

FIG. 7 is a side view similar to FIG. 6 showing progression of the erection process as the bottom wall forming elements are moved towards the bottom of the box;

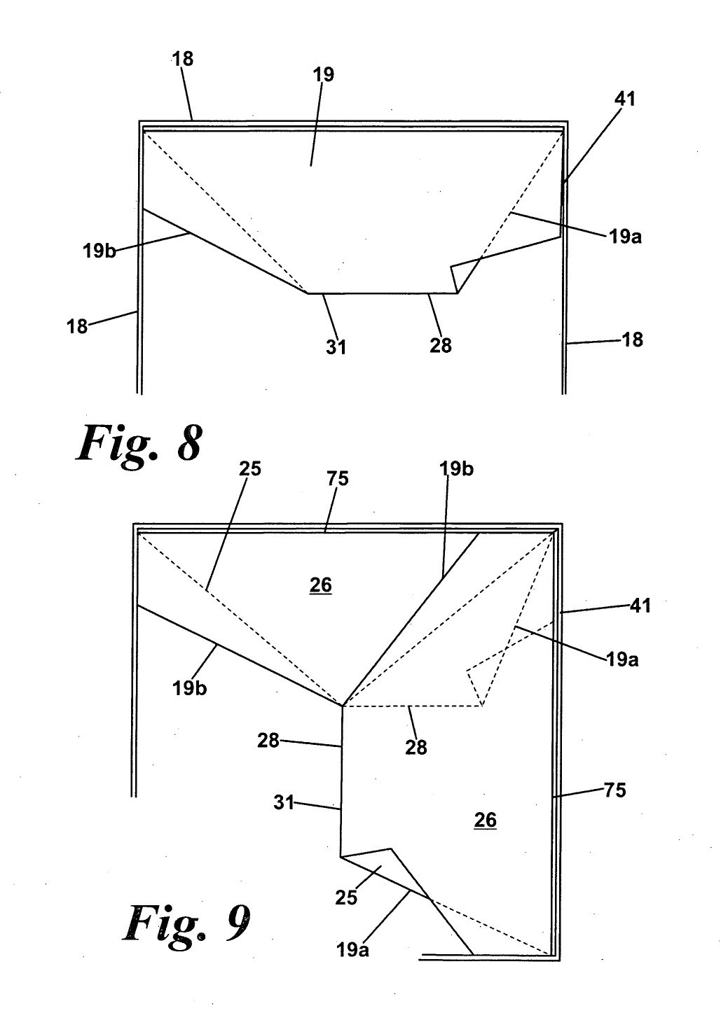

FIG. 8 is a plan view showing a single bottom wall forming panel in position after fully erecting the box;

FIG. 9 is a plan view similar to FIG. 8 but showing two neighbouring bottom wall forming panels in the fully erected box;

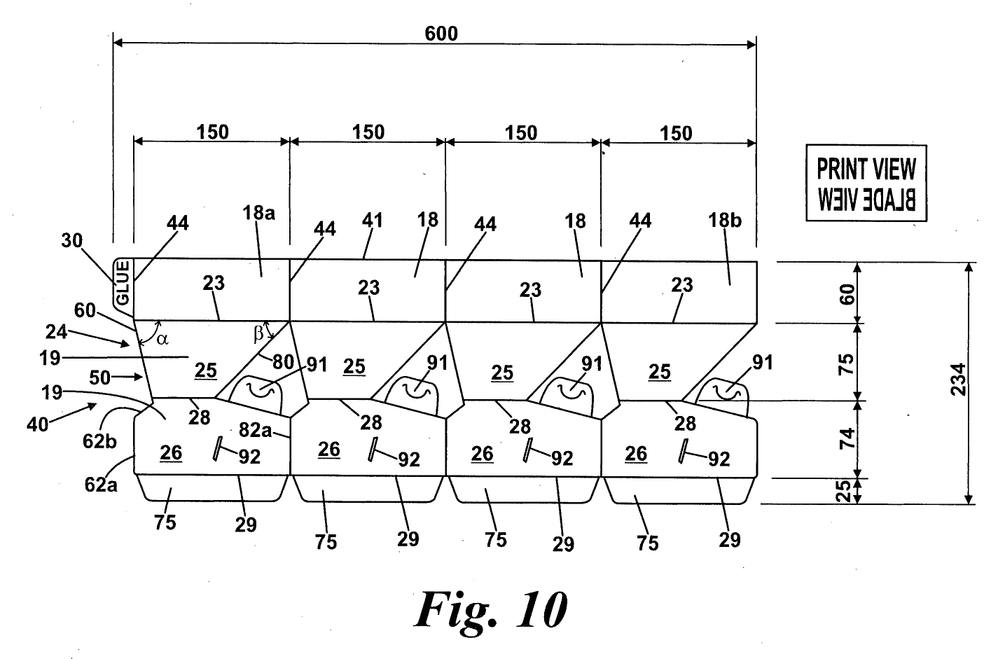

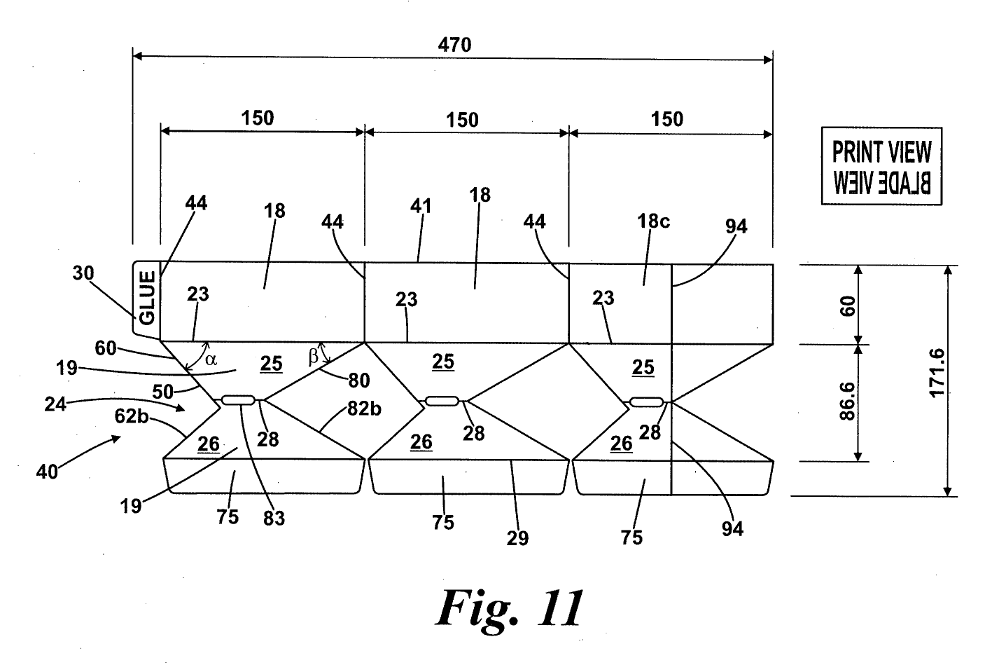

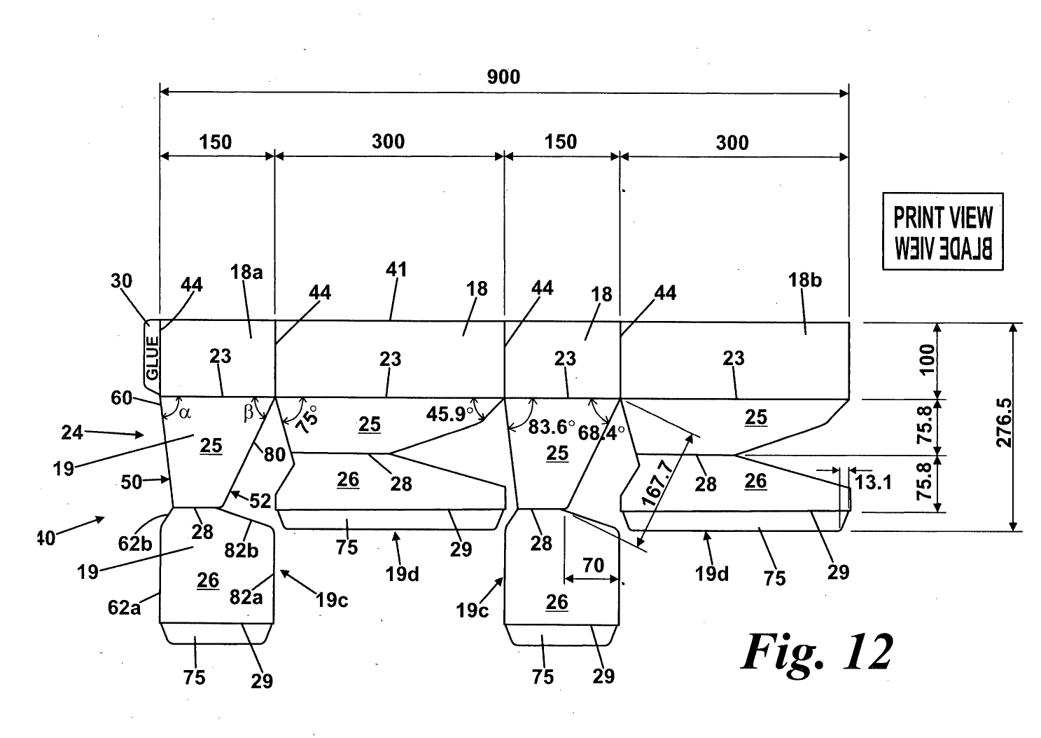

FIG. 10 is a similar view to FIG. 2 showing a further embodiment according to the present invention;

FIG. 11 is a similar view to FIG. 2 showing a further embodiment according to the present invention;

FIG. 12 is a similar view to FIG. 2 showing a further embodiment according to the present invention;

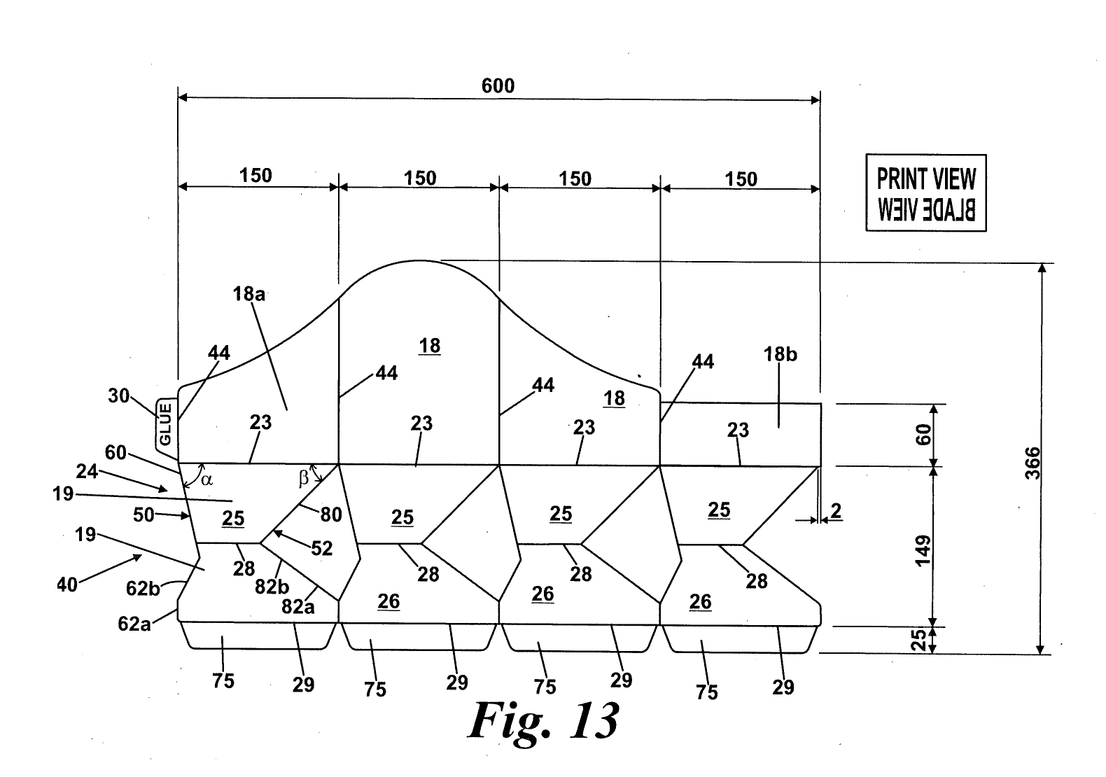

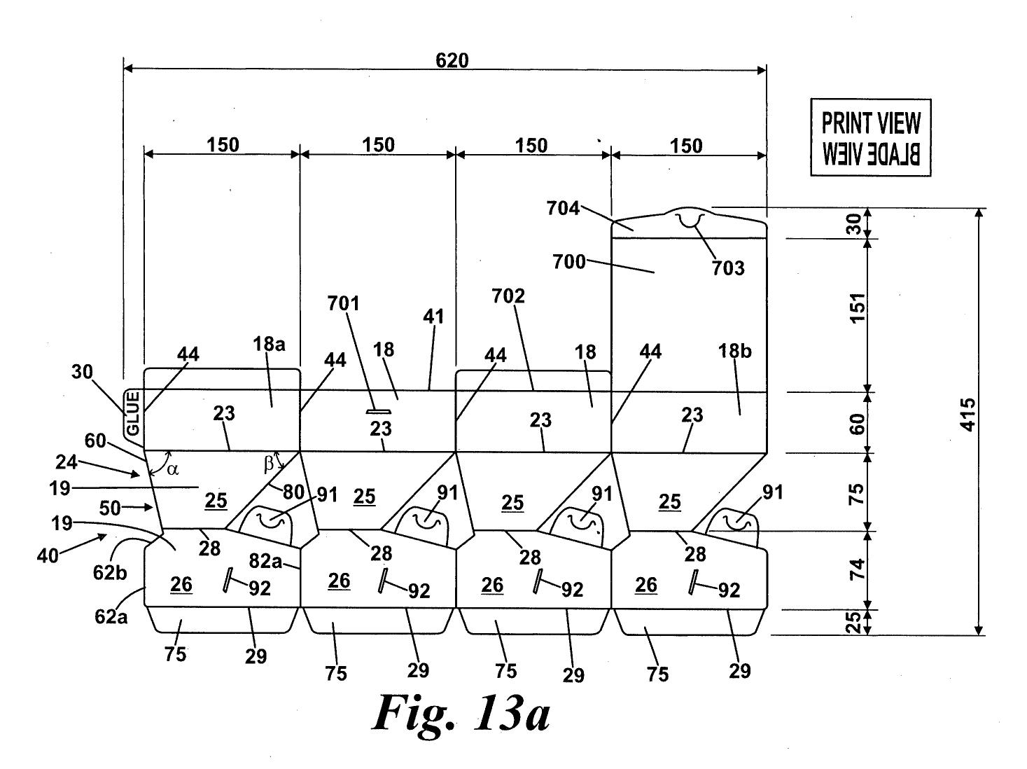

FIGS. 13 and 13a are a similar view to FIG. 2 showing two further embodiments according to the present invention;

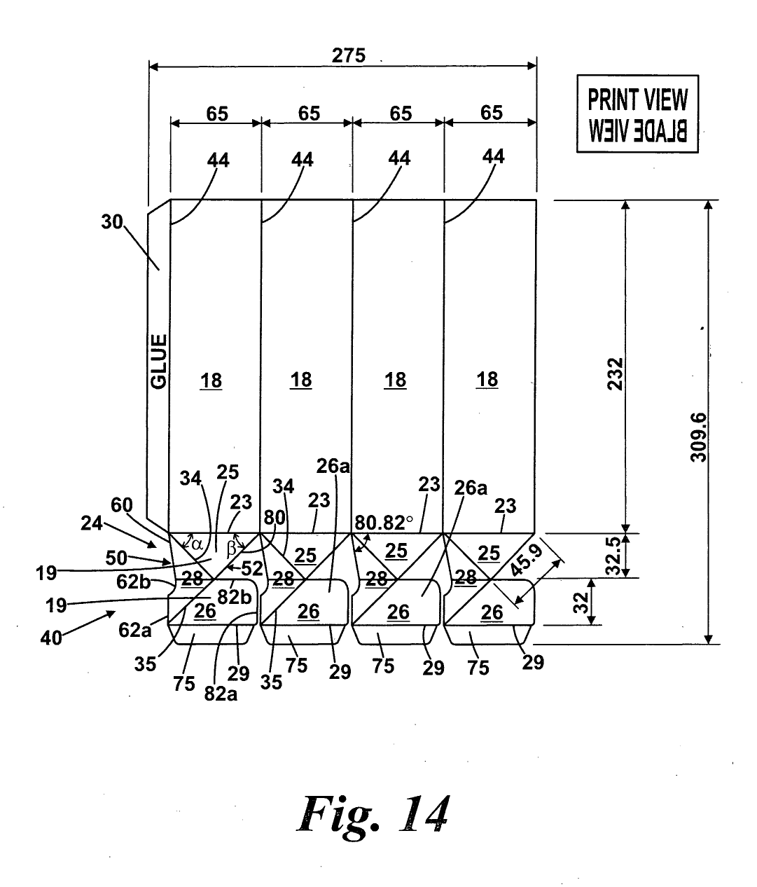

FIG. 14 is a similar view to FIG. 2 showing a further embodiment according to the present invention;

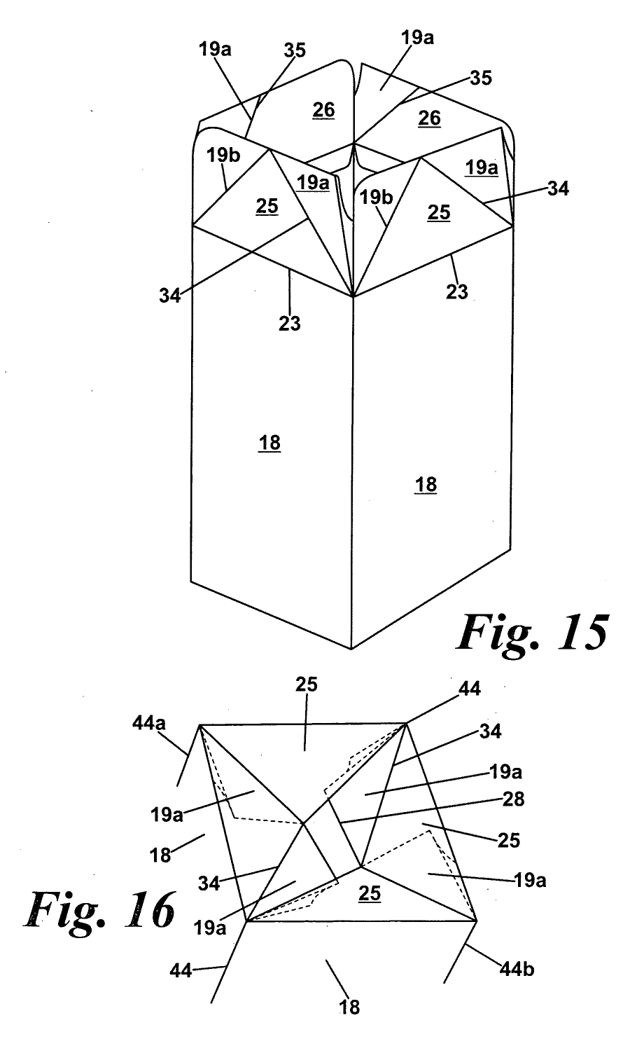

FIG. 15 is a schematic perspective view from below of the embodiment of FIG. 14 after the string of side wall forming panels have been joined to form a closed string and have been moved to form a tube;

FIG. 16 is a schematic part perspective view from below showing the box erected from the blank of FIG. 14 in the process of being collapsed to form a lay-flat condition;

FIG. 17 is a schematic plan view from below of the embodiment shown in FIG. 14 in its collapsed lay-flat condition;

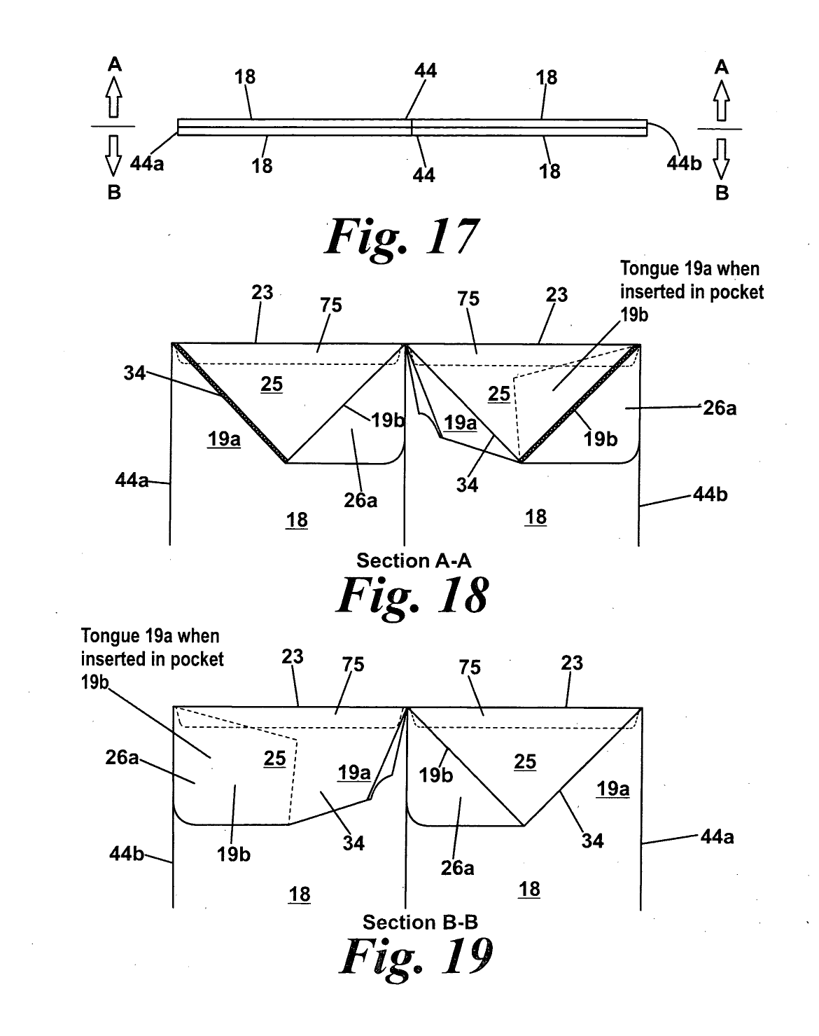

FIG. 18 is a schematic sectional view along line A-A in FIG. 17;

FIG. 19 is a schematic sectional view along line B-B in FIG. 17;

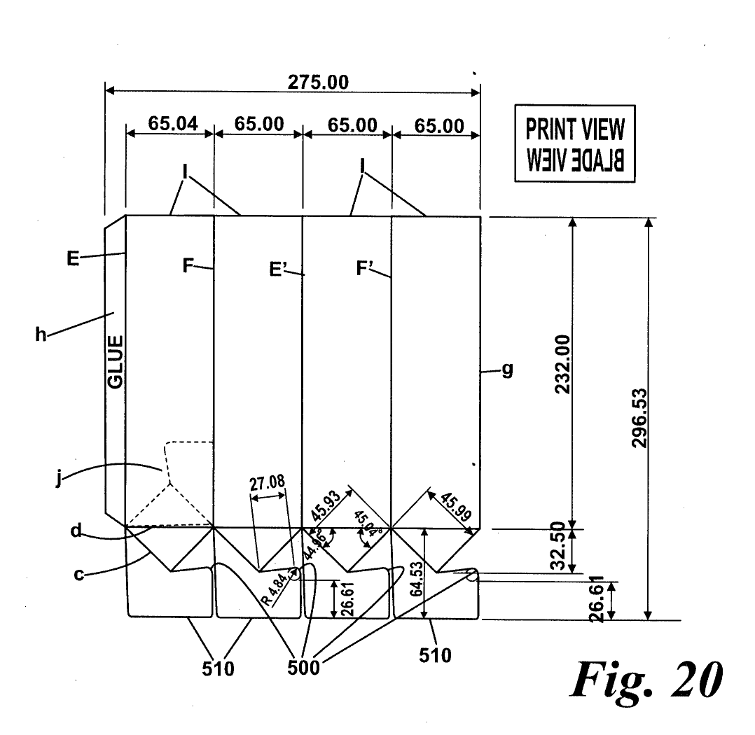

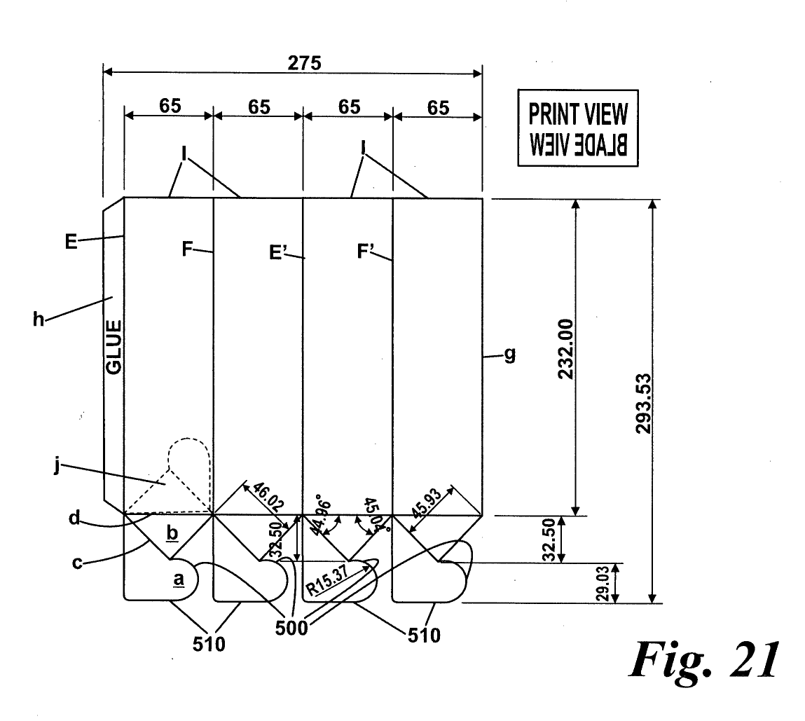

FIGS. 20-21 show variations of the embodiment of FIG. 14;

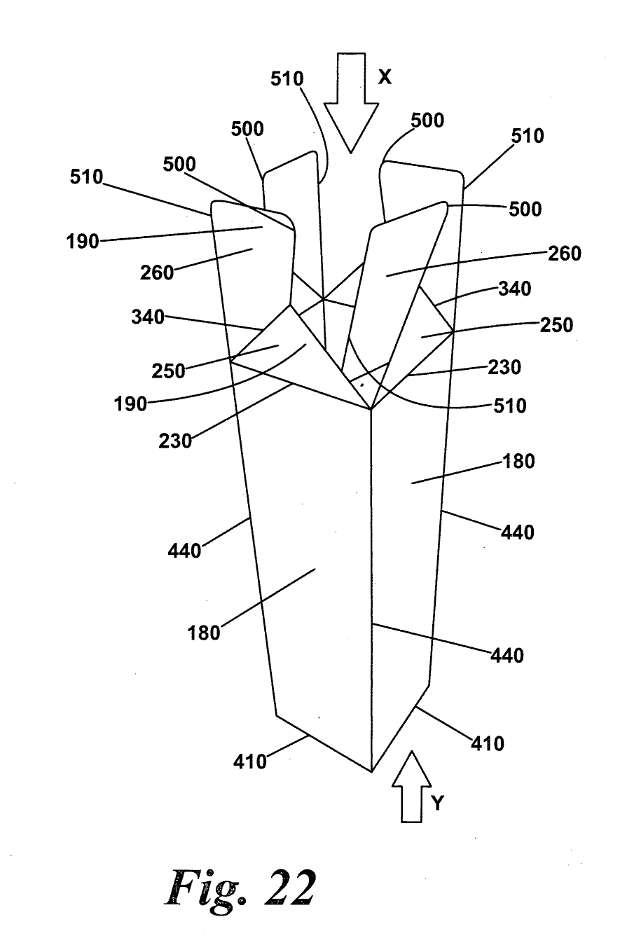

FIGS. 22-24 show the construction of a container from the blank of FIG. 20.

There is shown in FIG. 1 a four sided box 10 according to an embodiment of the present invention. The box 10 includes a box bottom wall 12 having a box side wall 14 extending about its periphery; the bottom wall 12 and side wall 14 collectively defining an enclosed space 16 for the box. The box side wall 14 continuously extends about the bottom wall 12 and so, in effect, defines a tube with the bottom wall being located at one end of the tube.

In this specification, the term ‘box’ is intended to indicate the general construction of the side wall 14 and bottom wall 12 to define the enclosed space 16 and is not intended to be interpreted as limiting the possible relative side wall to bottom wall size ratio or the possible use of the box; i.e. the term box may be interpreted, for example, to cover a container for storing articles in which the side wall has an axial extent similar to the width dimensions of the bottom wall, or a container of elongate tubular form which has a side wall having an axial extent far greater than the width dimensions of the bottom wall, or an arrangement in which the side wall has an axial dimension far less than the width dimensions of the bottom wall and so either defines a tray on which articles may be located, or a lid for a container.

Similarly the term ‘tube’ is not intended to be limiting in the sense of the length of the tube relative to its cross-sectional dimension; i.e. in this specification, the term tube embraces the situation where the axial extent of the tube is either greater than, equal to, or less than the cross-section width of the tube.

The side wall 14 is composed of a closed string of side wall forming panels 18 which are arranged side by side with neighbouring side wall forming panels being hingedly connected to one another. Each side wall forming panel 18 has associated with it a separate bottom wall forming panel 19; the separate bottom wall forming panels 19 of neighbouring hingedly connected side wall forming panels 18 collectively co-operate with one another to define the bottom wall 12 as the box is erected from the blank. In this respect, each bottom wall forming panel 19 has a first side portion which defines a tongue 19a (shown in broken lines in FIG. 9) projecting laterally of the panel 19 and a second side portion which defines a pocket 19b projecting laterally inwards of the panel 19 and into which the tongue of a neighbouring bottom wall forming panel is inserted in the erected box 10.

Each bottom wall forming panel 19 hingedly depends from the bottom edge 23 of its associated side wall forming panel 18. In one embodiment, each bottom wall forming panel 19 is composed of two superimposed layers of material having a space therebetween which in the region of the second side portion of the bottom wall forming panel defines a pocket 19b to receive the tongue 19a of a neighbouring bottom wall forming panel; the two layers respectively forming opposed upper and lower sides of the pocket.

As seen more clearly in FIG. 2, in this embodiment each bottom wall forming panel 19 is in the form of an independent flap 24 hingedly connected to the bottom edge 23 of the associated side wall forming panel 18, the flap 24 having a medial fold line 28 located between the bottom edge 23 and the terminal edge 29 of the flap 24. The flap 24 is therefore divided by the medial fold line 28 into a first flap portion 25 which is located between the bottom edge 23 and the medial fold line 28 and a second flap portion 26 which is located between the medial fold line 28 and the terminal edge 29. In the fully erected box 10, the first and second flap portions 25, 26 are folded about the medial fold line 28 to overlie one another and thereby define a two layered bottom wall forming panel 19. The folded medial line 28 defines an inner terminal edge 31 of the bottom wall forming panel 19 (FIGS. 4, 8, and 9).

In one preferred embodiment, as seen in FIG. 2, the side wall forming panels 18 and bottom wall forming panels 19 are formed from a single blank 40 of a sheet material 41 which is formed, preferably by appropriate cutting, scoring and/or creasing, to define an open string of side wall forming panels 18 wherein neighbouring panels 18 are hingedly connected to one another by foldlines 44.

The side wall forming panels 18a,18b located at the terminal ends of the string of side wall forming panels 18 are adapted for hingeable securance to one another to form, when secured together, a closed string of side wall forming panels 18, i.e. the closed string of side wall forming panels is able to form a continuous side wall 14 for surrounding the box bottom wall 12. Any accepted conventional method of fixing may be used for this purpose. In the embodiment illustrated in FIG. 2, panels 18a, 18b are adapted for hingeable securance to one another by side wall forming panel 18a being provided with a projecting tab 30 which is capable of being secured, preferably by a suitable glue such as a hot melt glue, to the inner face of the side wall forming panel 18b. In FIG. 2, the face of the blank 40 shown forms the outer face of the side wall and bottom wall of the erected box; this therefore means only this side needs to be printed in order to carry the graphics/information onto both the outer and inner surfaces of the erected box. The base panel 26, because of the way that it is folded, reverses around to display print on the inside surface of the base forming panels.

With a box having four side wall forming panels 18 it is possible for the closed string of side wall forming panels to be collapsed upon itself about foldlines 44 so that opposed side wall forming panels overlie one another with their inner faces in close proximity; in this condition the closed string of side wall forming panels are in a lay-flat condition. The closed string of side wall forming panels may also be moved about foldlines 44 to a fully erected condition (illustrated for example in FIG. 4) whereat the side wall forming panels are spaced apart to define a tube having a desired cross sectional polygonal shape (which polygonal shape is square in the case of the embodiment of FIG. 2 since each side wall forming panel 18 is of the same width dimension).

There is shown in FIG. 3, a blank 40 which has been prepared into the form of a collapsed box (in a lay-flat condition) which is ready to be erected. In the condition shown in FIG. 3, the tab 30 has been connected to form the closed string of side wall forming panels and in addition each of the separate flap portions 25 have been folded about the bottom edge 23 of their associated side wall forming panel 18 (e.g. through the closed string of side wall forming panels once the closed string has been created or folded about the respective bottom edges 23 prior to creating the closed string) to lie in a flat condition internally within the collapsed tube, and the separate flap portions 26 have been folded about medial foldlines 28 to lie flat against the outer face of their associated side wall forming panels 18. In this arrangement, each folded bottom wall forming panel sandwiches therebetween its associated side wall forming panel. The separate flap portions/bottom wall forming panels 25, 26 facilitate folding and ultimate formation of box 10. As shown in FIG. 3, the base wall forming panels 25, 26 project out through the string of side wall forming panels—the flap portion 25 is housed (although not necessarily completely) within the string of side wall forming panels 18.

As seen for example in FIGS. 4, 5, 8 and 9 each flap 24 has a first side 50 for forming the terminal edge of the tongue 19a of its bottom wall forming panel 19 and a second side 52 for forming the entrance edge of the mouth of the pocket 19b defined by the second side portion.

Preferably, the first side 50 and second side 52 are shaped so as to facilitate automatic entry of the tongue of one bottom wall forming panel into the pocket of a neighbouring bottom wall forming panel after the closed string of side wall forming panels has been moved to form a tube (i.e. when the closed string is moved about foldlines 44 to the fully erected condition of the closed string).

This condition is illustrated in FIG. 4 wherein it can be seen that the closed string of side wall forming panels 18 have been moved to form a tube of square cross-sectional shape. In this condition, the bottom wall forming panels 19 can be hingeably moved about bottom edges 23 inwardly of the tube in the direction of arrows A. By so moving the panels 19, the first flap portion 25 is moved about its hinged connection with bottom edge 23 of its associated side wall forming panel 18.

The second flap portion 26 is at the same time folded along foldline 28 such that the flap portion 26 lies approximately in a plane extending transversely of the tube. The second panel portions 26 are first moved inwardly along this transverse plane in the direction of arrows A and in so doing the edge 31 of each bottom wall forming panel defined by foldline 28 approaches the central axis of the tube and the terminal edge 29 of each second flap portion approaches the inner face of the associated side wall forming panel 18. This inward movement in the direction A can be provided by depression of the second flap portions 26 downwards through the closed string of side wall forming portions (i.e. axially towards the bottom of the tube (as defined by the bottom edges 23)).

During this movement of the second flap portions 26, the tongue 19a as defined by the first side portion of one bottom wall forming panel becomes located within the pocket 19b of the neighbouring bottom wall forming panel (as defined by the space in between the opposed first and second flap portions 25, 26 in the region of the second side portion of the bottom wall forming panel). The shapes of the first and second sides 50, 52 are such that as the second flap portions 26 are moved in the direction of arrows A, the side 52 of a given flap portion 25 at a first hinge position of flap portion 25 about edge 23 is able to pass by the side 50 of a neighbouring flap portion 25 as they hinge about their respective bottom edges 23 but at the same time, the side 52 of a given second flap portion 26 overlaps and is unable to pass by the side 50 of a neighbouring bottom wall forming panel 19. Accordingly, as the flap portions 25 pass by their first hinge position, the tongues of one bottom wall forming panel become introduced into the pocket of neighbouring bottom wall forming panel 19.

When the second flap portions 26 have been fully moved in the direction of arrows A, the edges 31 defined by foldlines 28 are preferably located close to the central axis of the tube and the terminal edges 29 are located adjacent to the inner faces of the side wall forming panels 18. This condition is illustrated in FIGS. 5 and 6. This movement also moves the tongues longitudinally further into their co-operating pockets; at the point where the terminal edges 29 are located adjacent to the inner faces of the side wall forming panels, the tongues are almost fully longitudinally inserted into their co-operating pocket.

To complete erection of the box, the bottom wall forming panels 19 are now pressed axially towards the bottom of the tube (as defined by the bottom edges 23). This causes the first flap portions 25 to hinge about bottom edges 23 and also the first and second flap portions to hinge about the foldlines 28.

The bottom wall forming panels 19 are moved axially towards the bottom of the tube until the flap portions 25, 26 engage one another in face to face contact at which point the bottom wall forming panels 19 lie in a transverse plane extending across the bottom end of the tube (as defined by the bottom edges 23). In this position, the marginal region of the second flap portion 26 located adjacent to the terminal edge 29 overlies the marginal portion of the first flap portion 25 located adjacent to the bottom edge 23; this provides a strong load bearing support for the bottom wall 12 (FIGS. 8, 9).

The box erection process described basically involves a three stage process, viz,

(1) moving the closed string of side wall forming panels 18 to form a tube,
(2) hingedly moving the flaps 24 about bottom edge 23, through the formed tube, and folding the flap portion 26 about fold line 28 to place the respective side wall forming panel 18 in between the flap portions 25 and 26 (the side wall forming panel 18 effectively sandwiched between the flap portions 25 and 26); and
(3) hingedly moving the flaps 24 back inwardly of the tube to initially automatically inter-engage the tongues (19a) and pockets (19b) of neighbouring bottom wall forming panels 19 and subsequently to move the inter-engaged bottom wall forming panels 19 to the bottom of the tube to define the box bottom wall 12.

This process is simple for both manual and robotic erection and also, for manual erection by an operative, it is intuitive. Steps (2) and (3) are facilitated by the separate nature of the base forming panels 25, 26.

The overlying nature of terminal edge 29 and associated bottom edge 23 helps to resist relative hingeable movement between the side wall forming panels and so resists collapse of the tube. In certain embodiments, a flap 75 foldably depends from each terminal edge 29 which in the fully erected box lies in face to face contact with the inner face of the associated side wall forming panel 18. This helps to resist lifting of the second flap portion 26 and also helps to reinforce the load bearing capacity of the bottom wall 12. The flaps 75 also help to resist bowing of the side wall forming panels.

It is envisaged that if desired, the terminal edge 29 and associate side wall panel 18 may be provided with inter-locking latch engagement means (eg a tongue projecting from edge 29 and a slot in the side wall forming panel 18 for receiving the tongue) in order to resist raising of the flap portion 26.

In order to increase the load bearing capacity of the bottom wall 12 it is envisaged that the neighbouring bottom wall forming panels 19 may be provided with inter-engaging latch means which act to prevent relative hingeable movement about their respective bottom edge 23; this in effect locks the overlapping bottom wall forming panels together and holds them in the transverse plane at the bottom of the tube. A suitable blank having latch means is illustrated in FIG. 10. In the embodiment shown in FIG. 10, flap portion 26 is provided with a projecting tab 91 which in the erected box is received within a co-operating slot 92 formed in the flap portion 26 of a neighbouring flap portion 26.

By way of illustration, suitable shaping of the sides 50, 52 to create automatic engagement of the tongues and co-operating pockets is illustrated in FIG. 2. The first side 50 is defined by side edge 60 of panel portion 25 and side edge 62 of panel portion 26. The second side 52 is defined by side edge 80 of panel 25 and side edge 82 of panel 26.

Opposed side edges 60 and 80 preferably extend in a rectilinear manner from opposite respective ends of bottom edge 23 to fold line 28, the edges 60, 80 each subtending an acute angle α,β respectively with bottom edge 23. Preferably angle α is greater than angle β so that edge 60 extends away from bottom edge 23 at a steeper angle than edge 80. Preferably angle α is less than 90° but greater than 45°. The angles α and β are chosen such that on hingable movement of neighbouring flap portions 25 inwards of the tube, side edge 80 is able to pass by side edge 60.

Specific examples for angles α and β for the embodiments shown in the following figures are:

| FIG. | α | | β | |
|---|---|---|---|---|
| 2 | 77.4 | degrees | 45.7 | degrees |
| 10 | 77.4 | degrees | 45.7 | degrees |
| 11 | 48.1 | degrees | 30.0 | degrees |
| 12 | 75, 83.6 | degrees | 45.9, 63.4 | degrees |
| 13 | 77.5 | degrees | 45.7 | degrees |
| 14 | 45.0 | degrees (to secondary crease) | 45.0 | degrees |
| | 80.8 | degrees (to edge 60) | | |

On panel portion 26, opposed side edges 62, 82 each preferably have a shoulder portion 62a, 82a respectively extending inwardly from the terminal edge 29 and an inclined portion 62b, 82b respectively extending outwardly from the foldline 28 to join its respective shoulder portion 62a, 82a.

Opposed shoulder portions 62a, 82a are aligned with the foldlines 44 and are preferably provided so as to abut against the inner face of neighbouring side wall forming panel 18 in the erected box in order to assist in resisting hingeable movement between adjacent side wall forming panels.

Side edge portions 62b, 82b are each inclined relative to the foldline 28 by a respective angle which enables the side edge 62b to readily enter beneath the side edge portion 82b of a neighbouring flap portion 26 during the hinging movement of the flap 24 inwardly of the tube whilst preventing the side edge portion 82b entering beneath side edge portion 62b.

In the above examples, the fold lines may be formed by creases and/or the creation of a line of weakness as formed by for example, perforations and/or scoring. An example of a foldline defined by a crease and perforation combination is illustrated by way of example in FIG. 11. In this embodiment, the foldline 28 is defined by a crease which extends either side from a slot-like aperture 83. This type of foldline is useful for releasing stresses about the foldline and may be used to advantage with resilient materials which when folded tend to have a high degree of resilience creating a bias about the foldline for returning the folded material back to its unfolded condition. The provision of a stress relieving foldline 28 such as that illustrated in FIG. 11 weakens such bias about the foldline.

In the embodiment shown in FIGS. 1 and 2, the string of side wall forming panels 18 includes an even number of such panels and so is readily able to be collapsed into a lay-flat condition after being formed into a closed string.

It is envisaged that the invention is applicable to boxes having a polygonal cross-section having any number of sides and by way of example a blank for a box having an odd number of sides is illustrated in FIG. 11. In FIG. 11 the blank is shown having three side wall forming panels 18 and in order to enable the string of three side wall forming panels to be collapsed into a flat condition after creating a closed string, one of the panels 18c and its associated flap 24 is provided with a medial fold line 94 which enables the panel 18c and its associated flap 24 to be folded upon itself. The same principle (i.e. providing one side wall forming panel having a medial foldline 94) for strings having any odd number of side wall forming panels.

In the embodiment of FIGS. 1 to 11, the box has a bottom wall 12 which has four equal length side edges 23, i.e. it has a square peripheral shape. As indicated above, other four sided polygonal shapes may be adopted and by way of example a blank capable of forming a box having a rectangularly shaped bottom wall 12 is illustrated in FIG. 12.

In the embodiment of FIG. 12, the bottom wall forming panels 19c associated with the side wall forming panels which form the narrow side walls of the box have flap portions 25, 26 of a greater length than the corresponding flap portions 25, 26 of the bottom wall forming panels 19d associated with the side wall forming panels which form the wide side walls of the box.

In the embodiments of FIGS. 1 to 12, the side wall forming panels 18 have a top edge which extends in a rectilinear manner. However, it is envisaged that the top edge of respective side wall forming panels may be profiled to define any desired shape for the top edge of the side wall in the erected box; by way of example an embodiment is illustrated in FIG. 13 which shows a string of four side wall forming panels of which three each have respective curved top edges. Furthermore, FIG. 13a illustrates a special situation where the side walls 18 have been extended and profiled such that terminal edge 41 has been replaced on three of the side panels 18 by crease lines 702. In addition, a panel 700 is provided to project from one of the side walls/crease lines 18/702, which when the box 10 is erected, can function as a lid. A tab/lock member 703 may be provided on a further panel 704 which foldably extends from the lid panel 700 such that it can engage with a suitably positioned slot 701 on opposing side wall 18.

In the embodiments of FIGS. 1 to 12, the side wall forming panels 18 each has a height which is less than the length (i.e. the distance between bottom edge 23 and foldline 28) of the respective flap portion 25; this enables the flap portion 26 of each bottom wall forming panel 19 to lie on the outside of the side wall forming panels 18 when in the lay flat condition. This in turn enables the erection of the box to be achieved from the upper end of the tube as illustrated and described with reference to FIGS. 6 to 8.

In the embodiment of FIG. 13, the height of some of the side wall forming panels 18 is in excess of the length of the respective flap portion 25. With this type of arrangement (where the length of each or some of the flap portions 25 is less than the height of their respective side wall forming panels 18) the lay flat condition is different to that shown in FIG. 3 in that flap portions 25, 26 of each bottom wall forming panel 19 lie in a co-planar relationship (i.e. they are not folded about the medial foldline 28). Erection of a box from the lay flat condition of this type of arrangement is similar to that for embodiments in FIGS. 1 to 12, viz, the side wall forming panels are initially moved about foldlines 44 to define the tube, and then the bottom wall forming panels 19 are manipulated (by folding flap portions 25 about edge 23 and flap portions 26 about foldline 28) to insert the tongue 19a of one bottom wall forming panels into the pocket 19b of a neighbouring bottom wall forming panel 19, and then moving the inter-engaged bottom wall forming panels downwardly from the upper end of the tube to its bottom end in the manner illustrated in FIGS. 5 to 7.

The manner of erection from a collapsed lay-flat condition for a box of the type illustrated and exemplified in the embodiments of FIGS. 1 to 13 is possible for boxes having bottom walls and side walls which are respectively wide enough and low enough to provide, from the upper end of the tube, access to the bottom wall panels during the erection process.

However, when the box has a side wall forming panel 18 having a height far in excess of the length of the respective flap portion 25, the method of erection is either not possible or unacceptably too difficult. Instead, an alternative method of erection is preferred as illustrated by way of example in FIGS. 14 to 19.

In the embodiment of FIG. 14, the box to be erected is of elongate form and can be used for example for the packaging of bottles.

Initially, the string of side wall forming panels 18 shown in FIG. 14 is formed into a closed string as in the embodiments of FIGS. 1 to 12. The side wall forming panels 18 are then moved about their respective foldlines 44 to form a tube with the flap portions 25, 26 of each bottom wall forming panel extending longitudinally beyond the bottom end of the tube. Each flap portion 26 is then folded, towards the interior of the tube, about its foldline 28 with its associated flap portion 25 so that the flap portion 26 lies in face to face contact with its associated flap portion 25 and thereby form a completed bottom wall forming panel 19. This condition is illustrated in FIG. 15.

With the tube in its erected condition as shown in FIG. 15, each bottom wall forming panel is folded towards the interior of the tube about the bottom edge 23 of its respective side wall forming panel 18 to reach a position whereat the bottom wall forming panels lie in the same plane across the bottom of the tube to define the box bottom wall 12. During this movement of the bottom wall forming panels 19, the tongues 19a of each bottom wall forming panel 19 is tucked into the pocket 19b of the neighbouring bottom wall forming panel 19 and so thereby form a fully erected box. Oblique foldlines 34, 35, which extend from a (e.g. more) central location of the bottom wall forming panels at one end to an outer location at the other end, are provided to facilitate tucking-in of adjacent tongues 19a into pockets 19b.

To create a collapsed, lay-flat, box as illustrated in FIG. 17, the side wall forming panels 18 are moved about the respective foldlines 44 to move opposed side wall forming panels toward one another whilst at the same time, the bottom wall forming panels 19 are moved about respective edges 23 into the interior of the tube. This process is shown in progress in FIG. 16. In this Figure, the tube is collapsed by pressing on opposed foldlines 44 whilst at the same time pressing the bottom wall forming panels 19 internally of the tube (this action moves opposed foldlines 44 closer to one another and moves opposed foldlines 44a, 44b further apart). Eventually, the fully collapsed condition illustrated in FIGS. 17 to 19 is achieved.

In this condition, the folded foldlines 44a, 44b define the extreme sides of the collapsed box. For each of the neighbouring pairs of side wall forming panels 18 joined by foldlines 44a, 44b respectively, the tongue 19a of one side wall forming panel 18 is located inside the pocket 19b of the neighbouring side wall forming panel 18. To enable the tongue 19a to be so located, it is hingedly connected to the remainder of the bottom wall forming panel by overlying oblique foldlines 34, 35 which are respectively formed in flap portions 25, 26. This arrangement of the inter-engaged tongues 19a and pockets 19b is more clearly shown in FIGS. 18, 19.

Also as shown in FIGS. 18 and 19, in the lay flat condition, the tongues 19a and pockets 19b located adjacent to the foldlines 44 located inboard from the foldlines 44a, 44b are dis-engaged. However, when erecting the box by moving the side wall forming panels to form a tube, these co-operating tongues 19a and pockets 19b become re-engaged by virtue of the bottom wall forming panels moving about bottom edges 23 toward the bottom wall position of the box.

The movement of the bottom wall forming panels 19 toward the bottom wall position of the box is brought about by two actions; viz (1) the bottom wall forming panels adjacent to foldlines 44a, 44b are automatically moved towards the bottom wall position due to the inter-engagement of their respective tongues 19a and pockets 19b as the side wall forming panels move to the fully erected tube condition, and (2) by holding the erected tube upright and inserting articles to be stored into the tube so as to bias (under the weight of the articles) the bottom wall forming panels 19 to the bottom wall position of the box.

To facilitate the entry of the tongues 19a into neighbouring pockets 19b located adjacent to the foldlines located inboard of foldlines 44a, 44b it is preferred to provide the flap portion 26 with a side extension 26a which, on initial movement of the side wall forming panels 18 to form the tube from the lay flat condition, acts to prevent the tongue 19a passing behind the neighbouring bottom wall forming panel 19 and thereafter acts to guide the tongue 19a towards and then into the mouth of the co-operating pocket 19b.

In all the above described embodiments, the tongue 19a is formed by two superimposed layers of material created when the associated flap portions 25, 26 are folded about the medial foldline 28; it will be appreciated that the tongues 19a may be formed in other ways, for example by suitable shaping of the side portions of the flap portions 25, 26 to create a tongue projection comprising a single layer of material (i.e. the material of either the flap portion 25 or 26).

Also in all the above embodiments, the pocket 19b is similarly formed by the folding of flap portions 25, 26 to lie one above the other to create a space therebetween to act as a pocket. It is envisaged that the pocket 19b for each bottom wall forming panel 19 may be formed in a different manner; for example a separate layer of material may be laid over and secured about part of its periphery in face contact with flap portion 25 to create a pocket space between the separate layer of material and the flap portion 25.

A number of variations to the embodiments discussed in relation to FIGS. 14-19 are shown in FIGS. 20-21. In these embodiments, the size of the developed tall container can be of the same order as that for FIGS. 14-19, and can provide the following common advantages/features:
1. have ‘separate’ base forming panels;
2. provide a box which is simple to erect from a lay-flat condition to the fully erected box condition;
3. be capable of both manual and auto erection;
4. be ‘Flat-Packed’ if so desired for transport and/or storage;
5. be able, when loaded, to display and carry the weight of a full bottle or similar container;
6. be closed at the top end by any industry standard method eg: Tuck end, Tab and Slot etc;
7. be manufactured using a range of both board and plastic materials;
8. be manufactured in a variety of weights from 125 micron up to 1000 micron.

The designs of FIGS. 20 and 21 are substantially identical in operation, the only difference being the size and profile of the bottom closing tabs; FIG. 20 being suited to plastic based products, and FIG. 21 to board based ones. However, it should be noted that FIG. 21 can be used for both board and plastic, but where strength and security are required, plastic is better suited to the longer profiles of FIG. 20. Board based products are very secure using the profile of FIG. 21, but can fail using the longer tabs of FIG. 20 by buckling when the contents are inserted. Hence, two designs are shown to give the user a ‘fit for purpose’ choice.

The assembly of both versions are substantially identical and therefore the following description, with reference to FIGS. 22-24, is focussed around the embodiment of FIG. 20 as an example. The product is taken from the flat die-cut state, as shown in FIG. 20, and folded along the vertical crease lines F and F′, this brings together the terminal edge ‘g’ onto the glue flap ‘h’ to form a closed string. The bottom forming panels 190 are then folded up as follows (FIG. 22).

The profiled tab section ‘a’/260 (having a leading edge 500 and a trailing edge 510), of a bottom wall forming panel 190, is folded inwards along the oblique crease line ‘c’/340 to lie on top of triangular flap ‘b’/250; this whole assembly is then folded inwards along base crease line ‘d’/230 to take up its final position ‘j’ as illustrated (FIG. 20/21). This is done for each bottom wall forming panel 190.

At this stage, the product can be creased along either fold lines E and E′, or F and F′ (440), to create a ‘Lay-Flat’ product suitable for transit or storage. To make up the box from this state opposite edges E E′ or F F′ are pushed towards each other to define a tube having a desired cross sectional polygonal shape, which in the case of the embodiment in FIG. 20 is a square since each side wall forming panel is of the same width. In an alternate embodiment, the closed string can be created by bringing together the terminal edge g onto the glue flap h after the folding along crease lines 340/230 i.e. the closed string is not created first (the same can be said for all other disclosed embodiments).

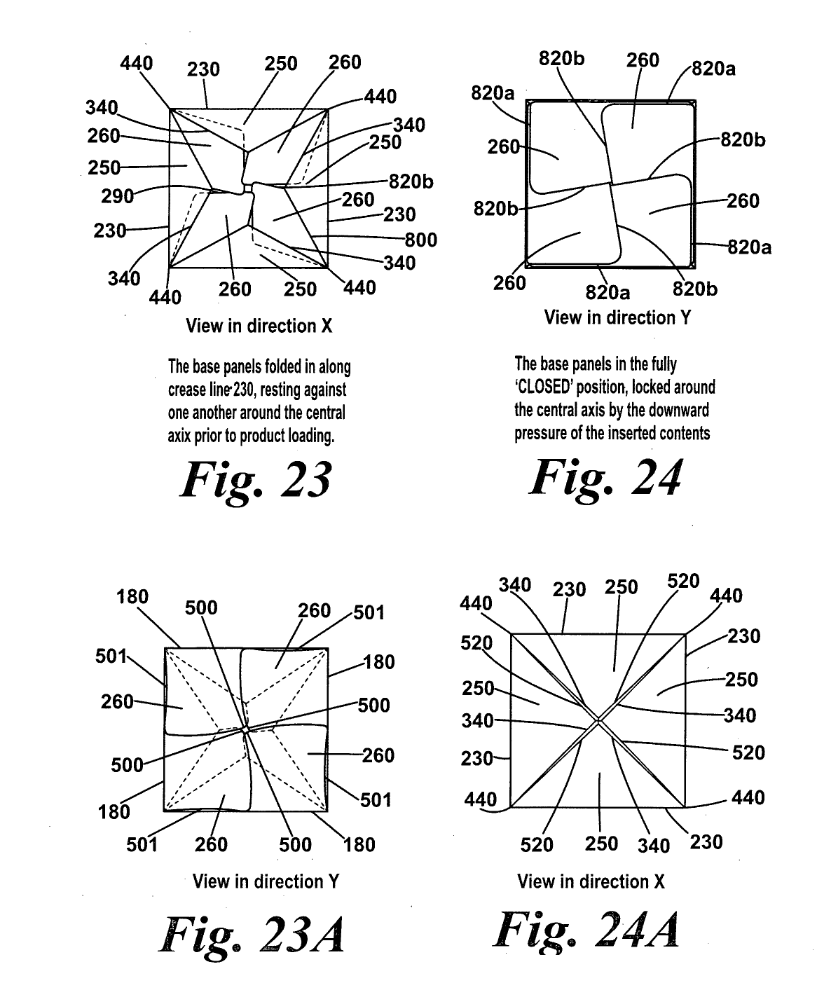

In this state, all of the bottom wall forming panels 190 move towards the central axis of the product with a ‘spring’ like action, they do not engage/lock/lay flat but rest together in a specific upstanding way to allow ‘locking’ and ‘loading’ (FIGS. 23/23A). It will be appreciated that the bottom wall forming panels 190 are upstanding internal to the closed string of side wall forming panels 180. It will be appreciated that the spring action is provided by the crease line 230 (and the properties of the material used to form the blank). In other less useful embodiments, the crease lines 230 (or 23) may not provide for a spring action which moves the tabs 260 towards the central longitudinal axis. The dimensions/shape of the bottom wall forming panels 190 (and particularly the dimension and shape of tab 260) are such that each leading edge of tab 260 can readily rest (or actually rests) on or towards the leading edge of an adjacent tab 260 when in the upstanding configuration (FIG. 23A).

At this point, because of the geometry (long thin tube) of the product, it is difficult to lock the bottom wall forming panels 190 together by using a human hand to push them down. Instead, the locking is performed by the loading action. As the contents (e.g. bottle) are inserted into the open top, as defined by edge ‘l’ in FIG. 20 (direction Y in FIG. 22), the weight of the product and its downward motion ‘Push’ the bottom wall forming (locking) panels 190 down to engage with each other in their final locking position (FIG. 24) and thus forming a secure bottom wall. The insertion of a loading element (e.g. product/bottle) pushes down on the upstanding bottom wall forming panels 190 such that the bottom wall forming panels 190 move back about crease line 230. Due to their specific upstanding configuration (provided by the specific shape/dimension of the tabs), the terminal ends of tabs 260 are moved to overlie the base ends of adjacent of tabs 260 (FIG. 24) in the bottom wall formed condition. It will be appreciated that folding about oblique crease line 340 provides for a double (or composite depending on the thicknesses) walled thickness bottom panel (over the cross section of flap 250), and provision of one tab 260 to overlie an adjacent tab 260 provides a triple walled/thickness (or further thickened) bottom.

The product can be sealed at the top “l” by any conventional closure method eg: Tuck Flap, Tab and Slot, etc (not shown).

In common with the other discussed embodiments, folding along a crease line (i.e. c/340) provides at least a two layered bottom wall forming panel 190. However, unlike the other embodiments, the crease lines are oblique and are not medial fold lines 28. The lines c/340 are oblique to the extent that when each of the adjacent flaps b/250 together create the base/bottom (i.e. they are in their respective final positions), they do not overlap one another (FIG. 24A). In certain embodiments, they are dimensioned such that they touch (or are spaced apart by a small amount, e.g. by 1 mm or so) along their diagonal edges.

It should be noted that although adjacent flaps 250 (FIG. 24A) do not overlap with or overlie one another, as discussed above, adjacent tabs 260 do overlap to create a locking arrangement (FIG. 24). The locking arrangement is different to that of the other disclosed embodiments in that folding along a crease line c/340 does not provide for adjacent tongues and pockets which interlock.

The material used as to form the various disclosed blanks may be paper, cardboard, plastic or combinations thereof. For example, the following types of material may be used:—

### 1) Boards

(a) Folding box boards weights from 150 micron to 650 micron;
(b) Corrugated boards from 2 mm to 6 mm thickness.

### (2) Polymers

(a) Polypropylene flat sheet weights from 180 micron to 1200 micron;
(b) Polyester flat sheet weights from 125 micron to 500 micron;
(c) PVC flat sheet weights from 125 micron to 500 micron;
(d) HIPS (High Impact Polystyrene) 250 micron to 750 micron.

### (3) Composites

(a) Suitable combinations of the above eg: 450 micron folding box board base with 125 micron polyester lid.

The above material types and weights can be considered to be representative of the most common that would be encountered for the cited embodiments in this document. However, material selection is made on a “fit for purpose” basis, therefore should the situation arise, types and weights outside of the above would be considered and manufacturing tolerances adjusted accordingly.

1. A box having a box sidewall composed of a closed string of side wall forming panels which defines a tube having a desired polygonal cross sectional shape, the side wall forming panels each having a bottom edge which together define one end of the tube, and a box bottom wall extending across and closing off said one end of the tube, the box bottom wall being composed of a plurality of separate side by side bottom wall forming panels, each separate bottom wall forming panel hingeably depending from a bottom edge of a respective side wall forming panel, each separate bottom wall forming panel having a tongue laterally projecting from one of its sides and a tongue receiving pocket laterally projecting inwardly from its opposite side, neighbouring bottom wall forming panels being inter-connected to one another by the tongue of one bottom wall forming panel being accommodated internally within the pocket of the neighbouring bottom wall forming panel.

2. A box according to claim 1 wherein each bottom wall forming panel comprises a pair of overlying layers creating a space therebetween, the space between the layers on one side of the bottom wall forming panel defining said tongue receiving pocket and the pair of layers on the opposite side of the bottom wall forming panel defining said tongue.

3. A box according to claim 2 wherein each bottom wall forming panel is in the form of a flap having a medial foldline parallel to the hinge line along the bottom edge of its associated side wall forming panel, the medial fold line dividing the flap into a first flap portion located between the bottom edge of the associated side wall forming panel and the medial fold line and a second flap portion located between the medial fold line and a terminal edge of the flap, the first and second flap portions being folded about the medial fold line to define said pair of overlying layers of the bottom wall forming panel, the folded medial foldline defining an inner terminal edge of the bottom wall forming panel.

4. A box according to claim 3 wherein the terminal edge of the flap is parallel to the medial fold line and is spaced therefrom by a distance such that the terminal edge is located close to the bottom edge of the associated side wall forming panel.

5. A box according to claim 4 wherein a marginal end flap is foldably attached to said terminal edge of the flap, the marginal end flap overlying the inner face of the associated side wall forming panel.

6. A box according to claim 1 wherein one or more respective pairs of bottom wall forming panels are provided with latch engagement means which co-operate to resist hingeable movement of each bottom wall forming panel about the bottom edge of its associated side wall forming panel.

7. A box according to claim 1, wherein said string is composed of an odd number of side wall forming panels, one of said side wall forming panels and its associated bottom wall forming panel each having a medial foldline extending parallel to the hinge connections between the side wall forming panels, said medial fold line providing for folding of one side wall forming panel and associated bottom wall forming panel in order to enable the side wall forming panels to assume said lay-flat condition from which the box can be erected.

8. (canceled)

9. (canceled)

10. A blank formed from a single sheet of material for forming a box, the blank being formed to define an open string of side wall forming panels with adjacent side wall forming panels being hingeably connected by respective foldlines, the blank also being formed to define respective separate bottom wall forming panels hingeably depending from a bottom edge of each side wall forming panel, and wherein the side wall forming panels located at the terminal end of the string are adapted for hingeable connection to one another in order to form, when connected, said closed string of side wall forming panels, the side wall forming panels being capable of being hingeably moved relative to one another to define said tube, each separate bottom wall forming panel being arranged to provide a tongue laterally projecting from one of its sides and a tongue receiving pocket laterally projecting inwardly from its opposite side, neighbouring bottom wall forming panels being arranged to be inter-connected to one another by the tongue of one bottom wall forming panel being accommodated internally within the pocket of the neighbouring bottom wall forming panel during forming of a box.

11. A blank according to claim 10, wherein the base wall forming panels are hinged from the bottom edge of each respective side wall panel to project out through the string of side wall forming panels.

12. (canceled)

13. A collapsed box in a lay-flat condition formed from a blank according to claim 10, wherein the base wall forming panels are hinged from the bottom edge of each respective side wall panel to project out through the string of side wall forming panels.

14. A collapsed box in a lay-flat condition formed from a blank according to claim 10, wherein the base wall forming panels are hinged from the bottom edge of each respective side wall panel to project out through the string of side wall forming panels, the side wall forming panels hinged by said side wall forming panel fold lines to define a lay-flat condition.

15. (canceled)

16. (canceled)

17. (canceled)

18. (canceled)

19. A method of forming a box using a blank according to claim 10, the method comprising hingeably joining the side wall forming panels located at opposite ends of the open string in order to form said closed string of side wall forming panels, moving the closed string of side wall forming panels relative to one another to form said tube, and hingeably moving the separate bottom wall forming panels toward the end of the tube defined by the bottom edges of the side wall in order to cause insertion of each tongue of one bottom wall forming panel into a co-operating pocket of a neighbouring bottom wall forming panel.

20. (canceled)

21. (canceled)

22. (canceled)

23. A box having a box sidewall composed of a closed string of side wall forming panels which defines a tube having a desired polygonal cross sectional shape, the side wall forming panels each having a separate bottom edge which together define one end of the tube, and a box bottom wall extending across and closing off said one end of the tube, the box bottom wall being composed of a plurality of separate side by side bottom wall forming panels, each separate bottom wall forming panel hingeably depending from a bottom edge of a respective side wall forming panel, each bottom wall forming panel having an oblique crease line to define a flap portion and a tab portion, the oblique crease line providing for folding of the tab portion over the flap portion to provide a composite thickness bottom wall, the tab portion configured to rest on the tab portion of an adjacent bottom wall forming panel in the erected box.

24. A blank formed from a single sheet of material for forming a box, the blank being formed to define an open string of side wall forming panels with adjacent side wall forming panels being hingeably connected by respective foldlines, the blank also being formed to define respective separate bottom wall forming panels hingeably depending from a bottom edge of each side wall forming panel, and wherein the side wall forming panels located at the terminal end of the string are adapted for hingeable connection to one another in order to form, when connected, said closed string of side wall forming panels, the side wall forming panels being capable of being hingeably moved relative to one another to define said tube, each bottom wall forming panel having an oblique crease line to define a flap portion and a tab portion, the oblique crease line providing for folding of the tab portion over the flap portion to provide a composite thickness bottom wall, the tab portion configured to rest on the tab portion of an adjacent bottom wall forming panel in the erected box.

25. A blank according to claim 24, wherein the blank is configured such that adjacent tab portions rest on one another in an upstanding configuration when the respective tab portions are folded about the respective oblique crease lines and the created folded tab/flap portions are internal to the closed string side wall forming panels.

26. A blank according to claim 24, wherein the blank is configured such that adjacent tab portions rest on one another in an upstanding configuration when the respective tab portions are folded about the respective oblique crease lines and the created folded tab/flap portions are hingedly moved about their respective bottom edges to be internal to the closed string side wall forming panels.

27. A method of forming a box comprising using the blank of claim 24, comprising hingeably joining the side wall forming panels located at opposite ends of the open string in order to form said closed string of side wall forming panels, moving the closed string of side wall forming panels relative to one another to form said tube and hingeably moving the separate bottom wall forming panels toward the end of the tube defined by the bottom edges of the side wall forming panels in order to cause adjacent tab portions to rest on one another to define an interlocking composite thickness bottom wall.

28. (canceled)

29. (canceled)

30. A method of forming a box using the blank of claim 24, the method comprising moving the closed string of side wall forming panels relative to one another to form said tube, and hingeably moving the separate bottom wall forming panels toward the end of the tube defined by the bottom edges of the side wall in order to cause adjacent tab portions to rest on one another to define an interlocking composite thickness bottom wall.

31. A method according to claim 30, comprising moving the bottom wall panels to be internal to the closed string prior to or following creation of the closed string of side wall forming panels.

32. (canceled)

33. A blank according to claims 25, wherein the blank is configured such that adjacent tab portions rest on one another in an upstanding configuration when the respective tab portions are folded about the respective oblique crease lines and the created folded tab/flap portions are hingedly moved about their respective bottom edges to be internal to the closed string side wall forming panels.
